(19) United States
(12) Patent Application Publication
(10) Pub. No.: US 2017/0210893 A1
(43) Pub. Date: Jul. 27, 2017

(54) POLYOLEFIN COMPOSITION

(71) Applicant: BASELL POLIOLEFINE ITALIA S.R.L., MILANO (IT)

(72) Inventors: MARCO CIARAFONI, FERRARA (IT); PAOLA MASSARI, FERRARA (IT); ROBERTO PANTALEONI, FERRARA (IT)

(73) Assignee: BASELL POLIOLEFINE ITALIA S.R.L., MILANO (IT)

(21) Appl. No.: 15/325,035

(22) PCT Filed: Jun. 29, 2015
(86) PCT No.: PCT/EP2015/064680

§ 371 Date: Jan. 9, 2017

(30) Foreign Application Priority Data
Jul. 7, 2014 (EP) 14175909.2

(51) Int. Cl. C08L 23/12

(52) U.S. Cl. CPC C08L 23/12; C08L 2205/02; C08L 2205/03; C08L 2207/02

(57) ABSTRACT

The present disclosure relates to a polyolefin composition comprising:
a propylene homopolymer, a copolymer of ethylene and propylene, and
an ethylene homopolymer with enhanced oligomer emission and gloss properties.

### FIELD OF THE INVENTION

The present disclosure relates to polyolefin compositions comprising a heterophasic propylene/ethylene copolymer and polyethylene for, in some embodiments, automotive interior elements characterized by low oligomer emissions and low gloss values.

### BACKGROUND OF THE INVENTION

Polyolefin compositions endowed with good combination of properties can be obtained by properly adding rubbers and polyethylene to the polypropylene.

For example, WIPO Pat. App. Pub. No. WO 2006/125720 relates to a polypropylene composition comprising (percentages by weight):

a) 65-77% of a crystalline propylene polymer having an amount of isotactic pentads (mmmm), measured by ¹³C NMR on the fraction insoluble in xylene at 25° C., higher than 97.5 molar % and a polydispersity index ranging from 5 to 10;

b) 8 to less than 13% of an elastomeric copolymer of ethylene and propylene, the copolymer having an amount of recurring units deriving from ethylene ranging from 30 to 70%, and being partially soluble in xylene at ambient temperature; the polymer fraction soluble in xylene at ambient temperature having an intrinsic viscosity value ranging from 2 to 4 dl/g; and

c) 10-23% of polyethylene having an intrinsic viscosity value ranging from 1.5 to 4 dl/g and optionally containing recurring units derived from propylene in amounts lower than 10%.

WIPO Pat. App. Pub. No. WO 2006/067023 relates to a polypropylene composition comprising (percentages by weight):

a) 50-77% of a crystalline propylene polymer having an amount of isotactic pentads (mmmm), measured by ¹³C NMR on the fraction insoluble in xylene at 25° C., higher than 97.5 molar % and a polydispersity index ranging from 4 to 10;

b) 13-28% of an elastomeric copolymer of ethylene and propylene, the copolymer having an amount of recurring units deriving from ethylene ranging from 30 to 70% that is partially soluble in xylene at ambient temperature, the polymer fraction soluble in xylene at ambient temperature having an intrinsic viscosity value ranging from 2 to 4 dl/g; and

c) 10-22% of polyethylene having an intrinsic viscosity value ranging from 1 to 3 dl/g and optionally containing recurring units deriving from propylene in amounts up to less than 10%.

However these documents do not take into account the optical properties of the resulting compositions that can be fine-tuned by balancing the melt flow rate of the various components.

The applicant has surprisingly found that a polyolefin composition having very low oligomer emissions and good gloss properties can be obtained in accordance with the present disclosure.

### SUMMARY OF THE INVENTION

An object of the present disclosure is a polyolefin composition comprising:

a) from 40.0 wt % to 58.5 wt % of a propylene homopolymer having the fraction insoluble in xylene at 25° C. higher than 96 wt %, and an melt flow rate MFR^{a} (ISO method 1133 (230° C. and 2.16 kg)) ranging from 95.0 to 200.0 g/10 min;

b) from 21.0 wt % to 30.0 wt % of a copolymer of ethylene and propylene having an amount of recurring units deriving from ethylene ranging from 35.0 wt % to 60.0 wt %, and the polymer fraction soluble in xylene at 25° C. of component a)+component b) having an intrinsic viscosity value ranging from 3.1 to 4.2 dl/g; and

c) from 20.5 wt % to 30.0 wt %%, of ethylene homopolymer;

wherein the composition has a melt flow rate MFR^{T} (ISO method 1133 (230° C. and 2.16 kg)) ranging from 9.0 to 30.0 g/10 min, and the ratio between the MFR of component a) MFR^{a} and the MFR of the total composition MFR^{T} MFR^{a}/MFR^{T} is between 5.0 and 15.0.

### DETAILED DESCRIPTION OF THE INVENTION

A further object of the present disclosure is a polyolefin composition comprising:

a) from 40.0 wt % to 58.5 wt %, such as from 45.0 wt % to 58.0 wt % and from 51.0 wt % to 57.5 wt %, of a propylene homopolymer having a fraction insoluble in xylene at 25° C. higher than 96 wt %, including higher than 97 wt %; and a melt flow rate MFR^{a} (ISO method 1133 (230° C. and 2.16 kg)) ranging from 95.0 to 200.0 g/10 min; such as from 100.0 to 180.0 g/10 min; from 110.0 to 160.0 g/10 min; and from 130.0 to 160.0 g/10 min;

b) from 21.0 wt % to 30.0 wt %, such as from 21.5 wt % to 27.5 wt %, and from 21.5 wt % to 24.5 wt %, of a copolymer of ethylene and propylene having an amount of recurring units deriving from ethylene ranging from 35.0 wt % to 60.0 wt %, including from 38.0 wt % to 55.0 wt %, from 41.0 wt % to 49.0 wt %, and from 44.0 wt % to 48.0 wt %, wherein the polymer fraction soluble in xylene at 25° C. of component a)+component b) has an intrinsic viscosity value ranging from 3.1 to 4.2 dl/g; and

c) from 20.5 wt % to 30.0 wt %, such as from 20.5 wt % to 27.5%, and from 21.0 wt % to 24.5 wt %, of ethylene homopolymer;

wherein the composition has a value of melt flow rate MFR^{T} (ISO method 1133 (230° C. and 2.16 kg)) ranging from 9.0 to 30.0 g/10 min, including from 10.0 to 25.0 g/10 min, and from 13.0 to 20.0 g/10 min; and the ratio between the MFR of component a) MFR^{a} and the MFR of the total composition MFR^{T}, MFR^{a}/MFR^{T} is comprised between 5.0 and 15.0; such as between 6.0 and 10.0; and between 6.5 and 9.5.

As used herein, the term “copolymer” includes polymers containing only two kinds of comonomers.

The features of the claimed composition such as the MFR ratio give rise to a polyolefin composition endowed with good mechanical and optical properties, including low gloss values beneficial for the production of automotive interior elements.

As used herein, an “automotive interior element” includes automotive interior parts such as door handles, door pockets, trim and parcel shelves, air ducts, heater/air conditioning unit casings, armatures for fascia panels, center consoles and carpeting.

In certain embodiments, the composition of the present disclosure exhibits a flexural modulus value between 800 and 1400 MPa, including between 900 and 1200 MPa.

In further embodiments, the gloss of the composition of the present disclosure is lower than 22%; including lower than 20%, lower than 19% and lower than 17%.

The composition of the present disclosure is obtained by means of a sequential copolymerization process.

In some embodiments, the sequential polymerization process comprises at least three sequential polymerization stages, with each subsequent polymerization being conducted in the presence of the polymeric material formed in the preceding polymerization reaction, wherein the polymerization stage of propylene to the crystalline polymer (a) is carried out in at least one stage, followed by a copolymerization stage of mixtures of ethylene with propylene to copolymer (b) and finally a polymerization stage of ethylene to polyethylene (c) are carried out.

The polymerisation stages may occur in liquid phase, in gas phase or liquid-gas phase. Preferably, the polymerisation of crystalline polymer (a) is carried out in liquid monomer (e.g. using liquid propylene as diluent), while the copolymerisation stages of copolymer (b) and polyethylene (c) are carried out in gas phase. Alternatively, all the three sequential polymerisation stages can be carried out in gas phase.

The reaction temperature in the polymerization stage for the preparation of crystalline polymer (a) and in the preparation of copolymer (b) and polyethylene (c) be the same or different, and may be from 40 to 100° C.; for instance, the reaction temperature may range from 50 to 80° C. in the preparation of polymer (a), and from 70 to 100° C. for the preparation of polymer components (b) and (c).

The pressure of the polymerization stage to prepare polymer (a), if carried out in liquid monomer, is the one which competes with the vapor pressure of the liquid propylene at the operating temperature used, and it may be modified by the vapor pressure of the small quantity of inert diluent used to feed the catalyst mixture, by the overpressure of optional monomers and by the hydrogen used as molecular weight regulator.

In some embodiments, the polymerization pressure ranges from 33 to 43 bar, if done in liquid phase, and from 5 to 30 bar if done in gas phase. The residence times relative to the two stages depend on the desired ratio between polymers (a), (b) and (c), and may range from 15 minutes to 8 hours. Conventional molecular weight regulators known in the art, such as chain transfer agents (e.g., hydrogen or ZnEt₂), may be used.

The polymerization stages may be carried out in the presence of a stereospecific Ziegler-Natta catalyst system.

The stereospecific Ziegler-Natta catalyst system, in some embodiments, comprise the product obtained by contacting (a) a solid catalyst component having an average particle size ranging from 15 to 80 m comprising a magnesium halide, a titanium compound having at least a Ti-halogen bond and at least two electron donor compounds one of which being present in an amount from 50 to 90% by mol with respect to the total amount of donors, wherein the first electron donor is selected from succinates and the second electron donor is selected from 1,3 diethers, (b) an aluminum hydrocarbyl compound and optionally (c) an external electron donor compound. In some embodiments, when the polyolefin composition is prepared using a polymerization process carried out in the presence of said stereospecific Ziegler-Natta catalyst, the resulting polyolefin composition is further advantageously endowed with a very low carbon emission rate.

The presence of these volatile compounds may be responsible for the odors of the interior of a new car. In some embodiments, it is desirable to reduce the amount of headspace emission according to VDA 277.

The values of carbon emission of the polyolefin composition according to the present invention, measured according to VDA 227 (C-emission), lower than 25.0 μg C/g; lower than 20.0 μg C/g; and lower than 17.0 μg C/g. In some embodiments, the value of the oligomer content of the composition of the present disclosure is lower than 3000 ppm, lower than 2500 ppm, and lower than 2200 ppm.

The features of the polyolefin composition of the present disclosure render the polyolefin composition beneficial for the production of automotive interior elements.

In some embodiments, the succinate electron donor in the solid catalyst component (a) is selected from succinates of formula (I) below:

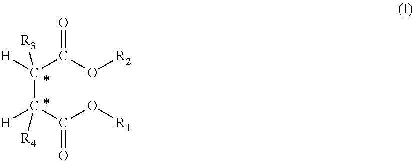

in which the radicals R₁ and R₂, equal to, or different from, each other are a C₁-C₂₀ linear or branched alkyl, alkenyl, cycloalkyl, aryl, arylalkyl or alkylaryl group, optionally containing heteroatoms; and the radicals R₃ and R₄ equal to, or different from, each other, are C₁-C₂₀ alkyl, C3-C20 cycloalkyl, C5-C20 aryl, arylalkyl or alkylaryl group such that at least one of them is a branched alkyl; wherein the compounds are, with respect to the two asymmetric carbon atoms identified in the structure of formula (I), stereoisomers of the type (S,R) or (R,S).

In some embodiments, R₁ and R₂ are C₁-C₈ alkyl, cycloalkyl, aryl, arylalkyl and alkylaryl groups. In additional embodiments, R₁ and R₂ are selected from primary alkyls such as branched primary alkyls. Examples of suitable R₁ and R₂ groups are methyl, ethyl, n-propyl, n-butyl, isobutyl, neopentyl and 2-ethylhexyl.

In further embodiments, compounds in which the R₃ and/or R₄ radicals are secondary alkyls such as isopropyl, sec-butyl, 2-pentyl and 3-pentyl or cycloakyls like cyclohexyl, cyclopentyl and cyclohexylmethyl groups may be used.

Examples of the above-mentioned compounds are the (S,R) and/or (S,R) forms in pure forms or in mixtures thereof, optionally in racemic form, of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate and diethyl 2,3-dicyclohexylsuccinate.

Among the 1,3-diethers mentioned above, in some embodiments compounds of the general formula (II):

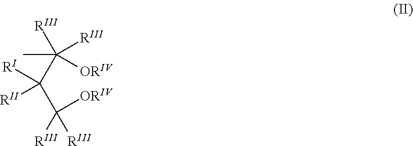

where R^{I} and R^{II} are the same or different and are hydrogen or linear or branched C₁-C₁₈ hydrocarbon groups which can also form one or more cyclic structures; R^{III} groups, equal or different from each other, are hydrogen or C₁-C₁₈ hydrocarbon groups; R^{IV} groups equal or different from each other, have the same meaning of R^{III} except that they cannot be hydrogen; each of R^{I} to R^{IV} groups can contain heteroatoms selected from halogens, N, O, S and Si, may be used.

In additional embodiments, R^{IV} is a 1-6 carbon atom alkyl radical including a methyl group, while the R^{III} radicals may be hydrogen. Moreover, when R_{I} is methyl, ethyl, propyl, or isopropyl, R^{II} can be ethyl, propyl, isopropyl, butyl, isobutyl, tert-butyl, isopentyl, 2-ethylhexyl, cyclopentyl, cyclohexyl, methylcyclohexyl, phenyl or benzyl; when R^{I} is hydrogen, R^{II} can be ethyl, butyl, sec-butyl, tert-butyl, 2-ethylhexyl, cyclohexylethyl, diphenylmethyl, p-chlorophenyl, 1-naphthyl, 1-decahydronaphthyl; R^{I} and R^{II} can also be the same and can be ethyl, propyl, isopropyl, butyl, isobutyl, tert-butyl, neopentyl, phenyl, benzyl, cyclohexyl, and cyclopentyl.

Specific examples of ethers that can be used in accordance with the present disclosure include: 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2(1-naphthyl)-1,3-dimethoxypropane, 2(p-fluorophenyl)-1,3-dimethoxypropane, 2(1-decahydronaphthyl)-1,3-dimethoxypropane, 2(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane,2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, and 2-cyclohexyl-2-cyclohexylmethyl-1,3-dimethoxypropane.

In some embodiments, the 1,3-diethers of formula (III) may be used:

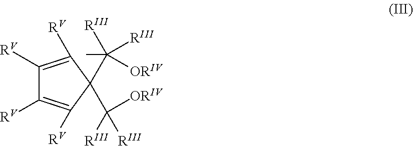

where the radicals R^{IV} have the same meaning explained above and the radicals R^{III} and R^{V} radicals, equal or different to each other, are selected from the group consisting of hydrogen, halogens such as Cl and F; C₁-C₂₀ alkyl radicals, linear or branched; C₃-C₂₀ cycloalkyl, C₆-C₂₀ aryl, C₇-C₂₀ alkaryl and C₇-C₂₀ aralkyl radicals and two or more of the R^{V} radicals that can be bonded to each other to form condensed cyclic structures, saturated or unsaturated, optionally substituted with R^{VI} radicals selected from the group consisting of halogens, preferably Cl and F; C₁-C₂₀ alkyl radicals, linear or branched; C₃-C₂₀ cycloalkyl, C₆-C₂₀ aryl, C₇-C₂₀ alkaryl and C₇-C₂₀ aralkyl radicals; said radicals R^{V} and R^{VI} optionally containing one or more heteroatoms as substitutes for carbon or hydrogen atoms, or both.

In additional embodiments, in the 1,3-diethers of formulae (I) and (II) all of the R^{III} radicals are hydrogen, and all the R^{IV} radicals are methyl. Moreover, 1,3-diethers of formula (II) in which two or more of the R^{V} radicals are bonded to each other to form one or more condensed cyclic structures, preferably benzenic, optionally substituted by R^{VI} radicals, may be used. In certain embodiments, compounds of the general formula (IV) may be used:

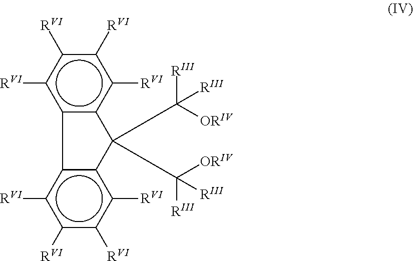

where the R^{VI} radicals equal or different are hydrogen; halogens such as Cl and F; C₁-C₂₀ alkyl radicals, linear or branched; C₃-C₂₀ cycloalkyl, C₆-C₂₀ aryl, C₇-C₂₀ alkylaryl and C₇-C₂₀ aralkyl radicals, optionally containing one or more heteroatoms selected from the group consisting of N, O, S, P, Si and halogens, such as Cl and F, as substitutes for carbon or hydrogen atoms, or both; the radicals R^{III} and R^{IV} are as defined above for formula (III).

Specific examples of compounds comprised in formulas (III) and (IV) are:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1-bis(methoxymethyl)indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl)indene;
1,1-bis(methoxymethyl)-7-trimethyisilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e]indene;
1,1-bis(methoxymethyl)-1H-2-methylbenz[e]indene;
9,9-bis(methoxymethyl)fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7-dicyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene; and
9,9-bis(methoxymethyl)-4-tert-butylfluorene.

As explained above, the catalyst component (a) may comprise, in addition to the above electron donors, a titanium compound having at least a Ti-halogen bond and an Mg halide. The magnesium halide may be MgCl₂ in active form, which is known from the patent literature as a support for Ziegler-Natta catalysts. For instance, U.S. Pat. Nos. 4,298,718 and 4,495,338 were the first to describe the use of these compounds in Ziegler-Natta catalysis. It is known from these patents that the magnesium dihalides in active form used as support or co-support in components of catalysts for the polymerization of olefins are characterized by X-ray spectra in which the most intense diffraction line that appears in the spectrum of the non-active halide is diminished in intensity and is replaced by a halo whose maximum intensity is displaced towards lower angles relative to that of the more intense line.

In some embodiments, titanium compounds used in the catalyst component of the present disclosure are TiCl₄ and TiCl₃; furthermore, Ti-haloalcoholates of formula Ti(OR)_{n-y}X_{y} can be used, where n is the valence of titanium, y is a number between 1 and n−1, X is halogen and R is a hydrocarbon radical having from 1 to 10 carbon atoms.

In certain embodiments, the catalyst component (a) has an average particle size ranging from 20 to 70 μm, such as from 25 to 65 μm. The succinate may be present in an amount ranging from 50 to 90% by weight with respect to the total amount of donors and may range from 60 to 85% by weight, including 65 to 80% by weight. In additional embodiments, the 1,3-diether constitutes the remaining amount.

The aluminum hydrocarbyl compound (b) is an aluminum hydrocarbyl compound in which the hydrocarbyl is selected from C₃-C₁₀ branched aliphatic or aromatic radicals; in some embodiments it is chosen among those compounds in which the branched radical is aliphatic and from branched trialkyl aluminum compounds selected from triisopropylaluminum, tri-iso-butylaluminum, tri-iso-hexylaluminum and tri-iso-octylaluminum. It is also possible to use mixtures of branched trialkylaluminums with alkylaluminum halides, alkylaluminum hydrides and alkylaluminum sesquichlorides such as AlEt₂Cl and Al₂Et₃Cl₃.

In additional embodiments, external electron-donor compounds c) include silicon compounds, ethers, esters such as ethyl 4-ethoxybenzoate, amines, heterocyclic compounds, 2,2,6,6-tetramethyl piperidine, ketones and 1,3-diethers. Another class of external donor compounds for use in the present technology is that of silicon compounds of the formula Rₐ⁵R_{b}⁶Si(OR⁷)_{c}, where a and b are integer from 0 to 2, c is an integer from 1 to 3 and the sum (a+b+c) is 4; R⁵, R⁶, and R⁷, are alkyl, cycloalkyl or aryl radicals with 1-18 carbon atoms optionally containing heteroatoms that may include methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane and 1,1,1,trifluoropropyl-metil-dimethoxysilane. The external electron donor compound may be used in such an amount as to give a molar ratio between the organo-aluminum compound and the electron donor compound of from 5 to 500, from 5 to 400 and from 10 to 200.

In step (i) the catalyst forming components may be contacted with a liquid inert hydrocarbon solvent such as, e.g., propane, n-hexane and n-heptane, at a temperature below about 60° C., such as from about 0 to 30° C., for a time period of from about six seconds to 60 minutes.

The catalyst components (a), (b) and optionally (c) may be fed to a pre-contacting vessel, in amounts such that the weight ratio (b)/(a) is in the range of 0.1-10. If the compound (c) is present, the weight ratio (b)/(c) is weight ratio corresponding to the molar ratio as defined above. In some embodiments, the components are pre-contacted at a temperature of from 10 to 20° C. for 1-30 minutes. The precontacting vessel can be either a stirred tank or a loop reactor.

In additional embodiments, the precontacted catalyst is then fed to the prepolymerization reactor where a prepolymerization step (i) takes place. The prepolymerization step is carried out in a first reactor selected from a loop reactor or a continuously stirred tank reactor. The prepolymerization can be carried out either in gas-phase or in liquid-phase. In some embodiments, the prepolymerization is carried out in liquid-phase. The liquid medium may comprise liquid alpha-olefin monomer(s), optionally with the addition of an inert hydrocarbon solvent. The hydrocarbon solvent can be either aromatic, such as toluene, or aliphatic, such as propane, hexane, heptane, isobutane, cyclohexane and 2,2,4-trimethylpentane. The amount of hydrocarbon solvent, in certain embodiments, is lower than 40% by weight with respect to the total amount of alpha-olefins, including lower than 20% by weight. In some embodiments, step (i)a is carried out in the absence of inert hydrocarbon solvents.

The average residence time in the reactor generally may range from 2 to 40 minutes, including from 10 to 25 minutes. The temperature ranges between 10° C. and 50° C., such as between 20° C. and 40° C. These conditions allow for a pre-polymerization degree in a range from 60 to 800 g per gram of solid catalyst component, including from 150 to 500 g per gram of solid catalyst component. Step (i)a is further characterized by a low concentration of solid in the slurry, for example in a range from 50 g to 300 g of solid per liter of slurry.

In some embodiments, the slurry containing the pre-polymerized catalyst is discharged from the pre-polymerization reactor and fed to the reactor where step (ii) takes place. Step (ii) can be carried out either in gas-phase or in liquid phase. The gas-phase process can be carried out in a fluidized or stirred, fixed bed reactor or in a gas-phase reactor comprising two interconnected polymerization zones, for instance where one is working under fast fluidization conditions and the other in which the polymer flows under the action of gravity. The liquid phase process can be either in slurry, solution or bulk (liquid monomer). The latter process can be carried out in various types of reactors such as continuous stirred tank reactors, loop reactors or plug-flow ones. The polymerization may be carried out at temperature of from 20 to 120° C., including from 40 to 85° C. When the polymerization is carried out in gas-phase the operating pressure is generally between 0.5 and 10 MPa, including between 1 and 5 MPa. In the bulk polymerization the operating pressure is generally between 1 and 6 MPa, such as between 1.5 and 4 MPa.

Conventional additives, fillers and pigments, commonly used in olefin polymers, may be added, such as nucleating agents, extension oils, mineral fillers, and other organic and inorganic pigments. For example, the addition of inorganic fillers, such as talc, calcium carbonate and mineral fillers, may bring about an improvement to the mechanical properties to the compositions disclosed herein, such as improved flexural modulus and HDT. Talc can also be used.

The nucleating agents may be added to the compositions of the present disclosure in quantities ranging from 0.05 to 2% by weight, such as from 0.1 to 1% by weight, with respect to the total weight.

The following examples are given to illustrate, without limiting, the present disclosure.

### Examples

The following analytical methods have been used to determine the properties reported in the detailed description and in the examples.

Xylene-Soluble Fraction at 25° C.

2.5 g of polymer and 250 mL of o-xylene are introduced in a glass flask equipped with a refrigerator and a magnetic stirrer. The temperature is raised in 30 minutes up to the boiling pint of the solvent. The resulting solution is then kept under reflux and stirring for further 30 minutes. The closed flask is then kept for 30 minutes in a bath of ice and water and in a thermostatic water bath at 25° C. for 30 minutes. The resulting solid is filtered on quick filtering paper and the filtered liquid is divided into two 100 ml aliquots. One 100 ml aliquot of the filtered liquid is poured into a previously weighed aluminum container, which is heated on a heating plate under nitrogen flow, to evaporate the solvent. The container is then kept on an oven at 80° C. under vacuum until a constant weight is obtained. The residue is weighed to determine the percentage of xylene-soluble polymer.

Ethylene (C2) Content

Ethylene content has been determined by IR spectroscopy.

The sample of a pressed film has been prepared according to ASTM D5576-00 (2013). The spectrum of a pressed film of the polymer is recorded as absorbance vs. wavenumbers (cm⁻¹). The following measurements are used to calculate C2 content:

a) Area (Aₜ) of the combination absorption bands between 4482 and 3950 cm⁻¹, which is used for spectrometric normalization of film thickness.

b) Area (A_{C2}) of the absorption band due to methylenic sequences (CH₂) after a proper digital subtraction of an isotactic polypropylene (IPP) reference spectrum. The range 660 to 790 cm⁻¹ is used for both heterophasic and/or random copolymers.

Molar Ratio of Feed Gasses

Determined by gas-chromatography.

Melt Flow Rate (MFR)

Determined according to ISO 1133 (230° C., 2.16 kg).

Intrinsic Viscosity

Determined in tetrahydronaphthalene at 135° C.

Flexural Modulus

Determined according to ISO 178.

Stress at Yield and at Break

Determined according to ISO 527.

Elongation at Yield and Break

Determined according to ISO 527.

IZOD Impact Strength

Determined according to ISO 18011A.

Melting Temperature, Melting Enthalpy and Crystallization Temperature

Determined by differential scanning calorimetry (DSC). A sample (6±1 mg) is heated to 220±1° C. at a rate of 20° C./min and kept at 220±1° C. for 2 minutes in a nitrogen stream and then cooled at a rate of 20° C./min to 40±2° C., and kept at this temperature for 2 min to crystallize the sample. The sample is then fused at a temperature rise rate of 20° C./min up to 220° C.±1. The melting scan is recorded, a thermogram is obtained, and melting temperatures and crystallization temperatures are determined.

Polydispersity Index (PI):

To determine the PI value, the modulus separation at low modulus value, e.g. 500 Pa, is determined at a temperature of 200° C. by using a RMS-800 (parallel plates) rheometer model (Rheometrics USA), operating at an oscillation frequency which increases from 0.01 rad/second to 100 rad/second. From the modulus separation value, the PI can be derived using the following equation:

PI=54.6×(modulus separation)^{-1.76};

wherein the modulus separation (MS) is defined as:

MS=(frequency at G′=500 Pa)/(frequency at G″=500 Pa);

wherein G′ is the storage modulus and G″ is the loss modulus.

Carbon Emission

Determined according VDA 277:1995.

Oligomer Content

The determination of oligomer content by solvent extraction consists of treating 5 g of a polypropylene sample with 10 ml of methylendichloride (CH2Cl2) into the vial. Oligomers from the sample are extracted by placing the vial into the ultrasonic bath at 25° C. for 4 hours. 1 μl of the extracted solution is injected into capillary column and analyzed by using flame ionization detection without any filtration. For quantitative estimation of oligomer content a calibration based on external standard method is applied. In one instance, a series of hydrocarbons (C12-C22-C28-C40) was used.

Gloss

10 rectangular specimens (55×60×1 mm) for each polymer to be tested are obtained by injection molding using a Battenfeld BA500CD operated under the following conditions:

Screw speed: 120 RPM

Back pressure: 10 bar

Mould temperature: 40° C.

Melt temperature: 260° C.

Injection time: 3 sec

First holding time: 5 sec

Second holding time: 5 sec

Cooling time (after second holding): 10 sec

The value of the injection pressure should be sufficient to completely fill the mold in the above indicated time span.

The glossmeter is a Zehntner Model ZGM 1020 or 1022 photometer set at an incident angle of 60°. The value reported corresponds to the mean gloss value over 10 specimens for each tested polymer. The measurement has been carried out according to ASTM D2457-13. The apparatus calibration is done with a sample having a known gloss value.

Samples for the Mechanical Analysis

Samples were obtained according to ISO 1873-2:2007, except for the flexural modulus, for which ISO 3167 was used.

Preparation of the Solid Catalyst Component of Examples 1 and 2

Into a 2000 mL five-necked glass reactor, equipped with mechanical stirrer, jacket and a thermocouple, purged with nitrogen, 1000 mL of TiCl₄ were introduced and the reactor cooled at −5° C. While stirring, 60.0 g of microspheroidal MgCl₂.1.7C₂H₅OH having average a particle size of 58 μm (prepared in accordance with the method described in Example 1 of EP728769) was added at −5° C. The temperature was raised at 40° C. and an amount of diethyl 2,3-diisopropylsuccinate was added to produce a Mg/succinate molar ratio of 13. The temperature was raised to 100° C. and kept at this value for 60 min. The stirring was stopped for 15 min and the solid settled. The liquid was siphoned off. After siphoning, fresh TiCl₄ and an amount of 9,9-bis(methoxymethyl)fluorene to produce a Mg/diether molar ratio of 26 was added. Then the temperature was raised to 110° C. and kept for 30 minutes under stirring. The reactor was then cooled at 75° C. and stirring was stopped for 15 min. After sedimentation and siphoning, fresh TiCl₄ was added. The temperature was raised to 90° C. and the suspension was stirred for 15 min. The temperature was then decreased to 75° C. and the stirrer was stopped for 15 min. After sedimentation and siphoning the solid was washed six times with anhydrous hexane (6×1000 ml) at 60° C. and one time with hexane at 25° C. The solid was dried in a rotavapor.

Preparation of the Solid Catalyst Component of Comparative Example 3

An initial amount of microspheroidal MgCl₂.2.8C₂H₅OH was prepared according to the method described in Example 2 of WIPO Pat. App. Pub. No. WO 98/44009 but operating on larger scale under conditions to produce an adduct having an average particle size of 25 am.

Preparation of the Solid Catalyst Component

Into a 500 mL four-necked round flask, purged with nitrogen, 250 ml of TiCl₄ are introduced at 0° C. While stirring, 10.0 g of microspheroidal MgCl₂.1.8C₂HOH (prepared according to the method described in Example 2 of U.S. Pat. No. 4,399,054, but operating at 3000 rpm instead of 10000 rpm) and 9.1 mmol of diethyl 2,3-(diisopropyl)succinate are added. The temperature is raised to 100° C. and maintained for 120 min. Then, the stirring is discontinued, the solid product was allowed to settle and the supernatant liquid is siphoned off. Then the following operations are repeated twice: 250 ml of fresh TiCl₄ are added, the mixture is reacted at 120° C. for 60 min and the supernatant liquid is siphoned off. The solid is washed six times with anhydrous hexane (6×100 mL) at 60° C.

Preparation of the Catalyst System for Examples 1 and 2 and Comparative Example 3

Before introducing it into the polymerization reactors, the solid catalyst component described above was contacted with triethyl aluminum (TEAL) and dicyclopentyldimethoxysilane (DCPMS) at a temperature of 15° C.

Prepolymerization

The catalyst system was then subjected to a prepolymerization treatment at 20° C. by maintaining it in suspension in liquid propylene for a residence time of 9 minutes before introducing it into the polymerization reactor.

Polymerization

The polymerization run is conducted in continuous mode in a series of three reactors equipped with devices to transfer the product from one reactor to the one immediately next to it. The first reactor is a liquid phase reactor, and the second and third reactors are fluid bed gas phase reactors. Polymer (a) is prepared in the first reactor, while polymers (b) and (c) are prepared in the second and third reactor, respectively.

Temperature and pressure are maintained constant throughout the course of the reaction. Hydrogen is used as molecular weight regulator.

The gas phase (propylene, ethylene and hydrogen) is continuously analyzed via gas-chromatography.

At the end of the run the powder is discharged and dried under a nitrogen flow. The polymerization conditions are reported in Table 2.

The polyolefin composition of Examples 1 and 2 and Comparative Example 3 have been extruded under a nitrogen atmosphere in a twin screw extruder, at a rotation speed of 250 rpm and a melt temperature of 200-250° C. with the additives reported in Table 1, and pelletized. The polymer features are reported in Tables 3 and 4.

TABLE 1

| Example | | 1 | 2 | Comp 3 |
|---|---|---|---|---|
| SONGNOX 1680(IRG.168) | wt % | 0.10 | 0.10 | 0.10 |
| Irganox 1010 | wt % | 0.05 | 0.05 | 0.05 |
| Calcium stearate | wt % | 0.05 | 0.05 | 0.05 |
| TALCO HM05 | wt % | 0.85 | 0.85 | 0.85 |

TABLE 2
Polymerization Conditions

| Example | | 1 | 2 | Comp. 3 |
|---|---|---|---|---|
| TEAL/solid catalyst | | 13 | 14 | 7.5 |
| component weight ratio | | | | |
| TEAL/DCPMS weight | | 6 | 6 | 4 |
| ratio | | | | |
| Liquid phase reactor | | | | |
| Polymerization | ° C. | 70 | 70 | 70 |
| temperature | | | | |
| Pressure | Barg | 39.3 | 39.3 | 40 |
| Residence time | min | 80 | 77 | 23 |
| H₂ bulk | Mol ppm | 5900 | 6400 | 3900 |
| 1^{st} gas phase reactor | | | | |
| Polymerization | ° C. | 80 | 80 | 80 |
| temperature | | | | |
| Pressure | Barg | 15 | 16 | 15 |
| Residence time | min | 18 | 14 | 15 |
| C₂⁻/(C₂⁻ + C₃⁻) | Mol ratio | 0.29 | 0.32 | 0.28 |
| H₂/C₂ | Mol ratio | 0.042 | 0.036 | 0.051 |
| 2^{nd} gas phase reactor | | | | |
| Polymerization | ° C. | 93 | 95 | 95 |
| temperature | | | | |
| Pressure | Barg | 16 | 17 | 15 |
| Residence time | min | 44 | 35 | 18 |
| C₂⁻/(C₂⁻ + C₃⁻) | Mol ratio | 0.97 | 0.97 | 0.98 |
| H₂/C₂ | Mol ratio | 0.35 | 0.35 | 0.2 |

H₂ bulk = hydrogen concentration in the liquid monomer;
C₂⁻ = ethylene;
C₃⁻ = propylene

TABLE 3
Composition Analysis

| Example | | 1 | 2 | Comp 3 |
|---|---|---|---|---|
| Component a) | | | | |
| propylene homopolymer | | | | |
| Homopolymer content | % wt | 56.5 | 56 | 40 |
| MFR | g/10 min | 121.0 | 150.0 | 65.0 |
| Xylene soluble fraction | % wt | 1.9 | 2.1 | 2.5 |
| Component b) | | | | |
| Propylene-ethylene copolymer | | | | |
| Copolymer content | % wt | 22.5 | 23 | 18 |
| Ethylene content | % wt | 43 | 46 | 40 |
| Xylene soluble fraction* | % wt | 26.5 | 26.7 | 21.5 |
| Intrinsic viscosity xylene soluble | dl/g | 3.38 | 3.58 | 3.00 |
| fraction* | | | | |
| Component c) | | | | |
| Polyethylene | | | | |
| Polyethylene content | % wt | 21 | 21 | 22 |
| Ethylene content (by calculation) | % wt | 100 | 100 | 100 |

*xylene soluble fraction of a) + b)

TABLE 4
Properties of the compositions

| Example | | 1 | 2 | Comp 3 |
|---|---|---|---|---|
| MFR | g/10′ | 17.6 | 16.7 | 14.0 |
| Flexural Modulus | MPa | 1130 | 1063 | 1110 |
| Izod at 23° C. | kJ/m² | 14.0 | 17.9 | 34.6 |
| Izod at 0° C. | kJ/m² | 11.3 | 13.3 | 10.2 |
| Izod at −20° C. | kJ/m² | 8.2 | 10.2 | 9.1 |
| Izod at −30° C. | kJ/m² | 7.8 | 9.2 | — |
| Tens. Str.@ yield | MPa | 19.8 | 18.3 | 20.9 |
| Elong. @ yield | % | 4.7 | 4.5 | 6.4 |
| Tens. Str.@ break | MPa | 16.3 | 15.3 | 14.7 |
| Elong.@ break | % | 8.1 | 9.0 | 21.0 |
| D/B TT | ° C. | <−50 | <−50 | <−50 |
| GLOSS 60′ | | 18 | 15 | 24 |
| Shrinkage (Long/Tras) | % | 1.26/1.33 | 1.28/1.35 | — |
| VOC (Sercovam FR lab) | ppm | 174 | 209 | — |
| C-emission VDA277 | mg C/g | 14.1 | 15.9 | 55.0 |
| Oligomers | ppm | 2000 | 2060 | 4585 |
| MFRa/MFRt | | 6.9 | 9.0 | 4.6 |

1. A polyolefin composition comprising:
a) 40.0-58.5 wt % of a propylene homopolymer having a fraction insoluble in xylene at 25° C. higher than 96 wt % and a melt flow rate (MFR^{a} ISO Method 1133 (230° C. and 2.16 kg)) of 95.0-200.0 g/10 min;
b) 21.0-30.0 wt % of a copolymer of ethylene and propylene having an amount of recurring units deriving from ethylene ranging from 35.0-60.0 wt % and a polymer fraction soluble in xylene at 25° C. of component a)+component b) having an intrinsic viscosity value of 3.1-4.2 dl/g; and
c) 20.5-30.0 wt % of ethylene homopolymer;
wherein composition has a melt flow rate (MFR^{T} ISO Method 1133 (230° C. and 2.16 kg)) ranging from 9.0-30.0 g/10 min, and the ratio between the MFR of component a) MFR^{a} and the MFR of the total composition MFR^{T} MFR^{a}/MFR^{T} is 5.0-15.0.

2. The polyolefin composition of claim 1, wherein component a) ranges from 45.0-58.0 wt %, component b) ranges from 21.5-27.5%, and component c) ranges from 20.5-27.5%.

3. The polyolefin composition of claim 1 wherein in component b) the amount of recurring units deriving from ethylene ranges from 38.0 wt %-55.0 wt %.

4. The polyolefin composition of claim 1, wherein the ratio between the MFR of component a) MFR^{a} and the MFR of the total composition MFR^{T} MFR^{a}/MFR^{T} is from 6.0 and 10.0.

5. The polyolefin composition of claim 1, wherein the flexural modulus value is from 800-1400 MPa.

6. The polyolefin composition of claim 1, wherein the gloss of the composition is lower than 22%.

7. The polyolefin composition of claim 1, wherein the carbon emission values, measured according to VDA 227 (C-emission), are lower than 25.0 μg C/g.
